(19) United States
(12) Patent Application Publication
(10) Pub. No.: US 2017/0103395 A1
(43) Pub. Date: Apr. 13, 2017

(54) AUTHENTICATION SYSTEMS AND METHODS USING HUMAN READABLE MEDIA

(71) Applicant: Glenn Cobourn Everhart, Smyrna, DE (US)

(72) Inventor: Glenn Cobourn Everhart, Smyrna, DE (US)

(21) Appl. No.: 11/567,903

(22) Filed: Dec. 7, 2006

Related U.S. Application Data
(63) Continuation-in-part of application No. 11/137,409, filed on May 26, 2005.
Application No. 11/137,409 is a continuation-in-part of application No. 10/419,107, filed on Apr. 21, 2003, now Pat. No. 7,899,753.
Application No. 10/419,107 is a continuation-in-part of application No. 10/105,471, filed on Mar. 25, 2002, now abandoned.

(51) Int. Cl. G06Q 20/40; G06F 3/0482; G06F 3/0488; G06Q 20/32

(52) U.S. Cl. CPC G06Q 20/4014; G06Q 20/322; G06F 3/0482; G06F 3/0488

(57) ABSTRACT

The invention provides a method and system for authenticating a financial transaction using a display on a customer device. The method may include outputting display data to a customer, the display data for generating a display on a display portion of the customer device, the display data including (1) at least one image, and (2) coordinates at which to display the image on the display portion. The method may further include inputting selected coordinates from the customer, the selected coordinates representing positions on the customer's display portion that the customer selected; comparing the selected coordinates, which were input from the customer, vis-à-vis the display data so as to effect an authentication determination; and outputting the results of the authentication determination to the customer.

### RELATED APPLICATIONS

This patent application is a Continuation-in-Part (CIP) application of U.S. patent application Ser. No. 11/137,409 filed May 26, 2005 (Attorney Docket No. 47004.000322), which is a Continuation-in-Part (CIP) application of U.S. patent application Ser. No. 10/419,107 filed Apr. 21, 2003 (Attorney Docket No. 47004.000204), which is a Continuation-in-Part (CIP) application of U.S. patent application Ser. No. 10/105,471 filed Mar. 25, 2002, all three of which are incorporated by reference into the present application in their entirety.

### BACKGROUND OF THE INVENTION

Many transactions depend on each party being able to know who the other is and relying on that knowledge in the exchange of confidential information. Many theft schemes have been devised over the years and succeed because of the difficulty of effectively performing this exchange. While a number of systems have been proposed to facilitate such knowledge, most have been either expensive or incomplete.

In some known systems, authenticators use one set of digits which are entered to validate a token and a second set which are used to validate a person. It is particularly a problem that prior practice tends to include unencrypted entry of the consumer's PIN, to have a fixed authenticator, and that often the payment information is expected to be entered into devices which are connected to networks and which can be spied upon in various ways.

The proposed system described herein lacks these problems and others.

### BRIEF SUMMARY OF THE INVENTION

The invention provides a method and system for authenticating a financial transaction using a display on a customer device. The method may include outputting display data to a customer, the display data for generating a display on a display portion of the customer device, the display data including (1) at least one image, and (2) coordinates at which to display the image on the display portion. The method may further include inputting selected coordinates from the customer, the selected coordinates representing positions on the customer's display portion that the customer selected; comparing the selected coordinates, which were input from the customer, vis-à-vis the display data so as to effect an authentication determination; and outputting the results of the authentication determination to the customer.

### BRIEF DESCRIPTION OF THE DRAWINGS

The present invention can be more fully understood by reading the following detailed description together with the accompanying drawings, in which like reference indicators are used to designate like elements, and in which:

FIG. 1 is a diagram showing a token in accordance with one embodiment of the invention;

FIG. 2 is a diagram showing a further token with signing indicia in accordance with one embodiment of the invention;

FIG. 3 is a diagram showing a further token in accordance with one embodiment of the invention;

FIG. 4 is a diagram showing the token of FIG. 3 illustrating signing of an amount in accordance with one embodiment of the invention;

FIG. 5 shows a further token in accordance with one embodiment of the invention;

FIG. 6 shows a yet further token in accordance with one embodiment of the invention;

FIG. 7 is a block diagram showing an authentication system in accordance with one embodiment of the invention;

FIG. 8 is a diagram showing a display in accordance with one embodiment of the invention;

FIG. 9 is a flowchart showing a process of authentication in accordance with one embodiment of the invention; and

FIG. 10 is a further flowchart showing a process of authentication in accordance with one embodiment of the invention.

### DETAILED DESCRIPTION OF THE INVENTION

Hereinafter, aspects of the authentication scheme in accordance with various embodiments of the invention will be described. As used herein, any term in the singular may be interpreted to be in the plural, and alternatively, any term in the plural may be interpreted to be in the singular.

The proposed system allows the use of very simple and inexpensive devices and communication systems to (1) authenticate a person attempting a transaction (as opposed to simply authenticating the presence of some token), (2) authenticate the authenticating entity to the customer, and/or (3) sign transactions electronically (e.g. regarding the amount of a transaction), using simple and small messages which can be used in existing payment networks.

That is, the proposed system provides multi-factor authentication and also transaction signing. The invention may use small messages which can be used in place of existing payment messages. The authentication number (or other indicia), described below, can be used in place of the 3 or 4 digit Card Validation Value or in place of a conventionally entered PIN. As a result, the embodiments of the invention can work with existing websites, phone order systems, or merchant systems without change to POS systems or to networks, and with only minor changes at the issuer system to check the entered values.

In accordance with one embodiment of the invention, the idea is that one can use printed numbers or letters on cards or the like, made up so that each is different from the others, and distributed to customers. The scheme is used to authenticate the customers to an authenticating entity (e.g., a bank), to authenticate the entity (e.g., bank) to the customer, and to allow the customer to, in effect, sign a transaction by a combination of selections from the printed material.

In the invention, the customer or other participant (or participants) in a transaction performs a transform on a particular number on the bingo card. By using this multi-layered authentication, the security of the authentications achieved can be made much stronger than any single selection would provide.

In my prior application, U.S. patent application Ser. No. 11/137,409 filed May 26, 2005 (Attorney Docket No. 47004.000322), I proposed some functions with a variable display device that give added authentication functions. The present invention proposes use of functions in conjunction with a token being in the form of a “bingo card” as characterized herein. The bingo card may possess a set of “random numbers,” each card having different numbers. That is, the numbers need not really be random, but need to be apparently so to a casual observer, and the numbers need to be known to (or easily recomputable by) the authenticating entity (e.g., bank). The numbers should be different enough from card to card so that a person with several cards cannot use their contents to guess a different card's contents. The bingo card, i.e., token, might be in the form of indicia printed on a suitable medium or an electronic device that electronically displays indicia.

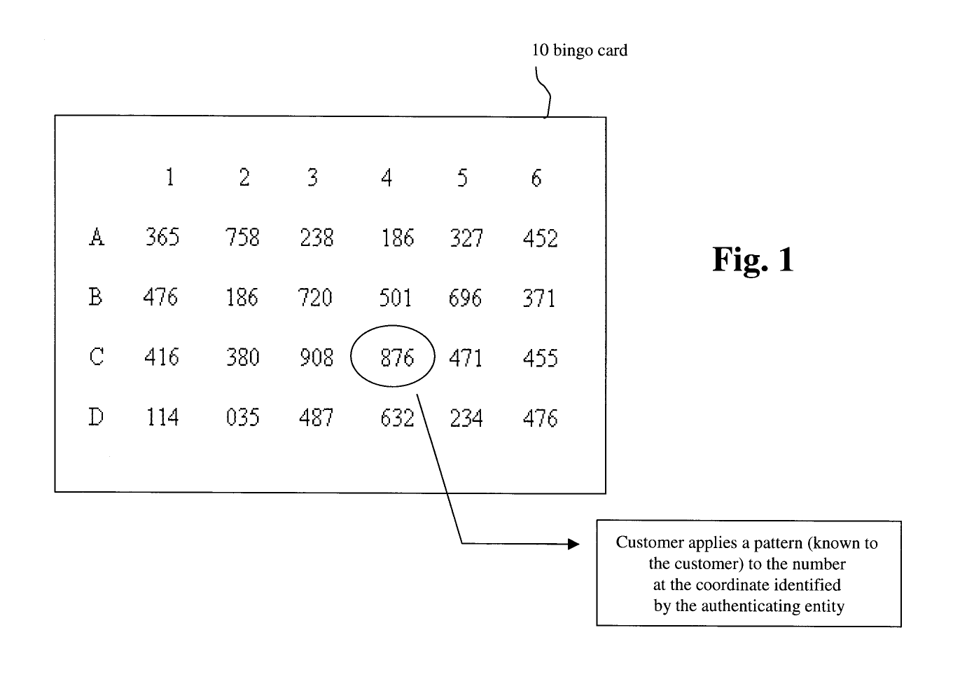

FIG. 1 is a diagram illustrating a token in accordance with one embodiment of the invention. That is, FIG. 1 shows a bingo card 10. The particular number of values in the card may be varied as desired. For example, the card of FIG. 1 could be provided with more columns and rows, and associated numbers.

In accordance with one embodiment of the invention, using the card of FIG. 1, the bank refers the customer to coordinate C-4. The customer then takes the number at C-4, i.e., 876, and applies a previously determined transform to the number. For example, the customer could rearrange the order of the digits or add some value to the number at C-4. Thus, in response, the customer provides the bank with the transformed number, thus showing the customer has the card and that the customer has applied the predetermined transformation.

The bank might send new cards out every month with the statements. Further, scratch-off cards might be used so the inner numbers are hidden until used. Thus, the card of FIG. 1 and use thereof authenticates that the CARD is present, and effectively conveys WHO has the card, i.e., by the customer performing the transform.

Various authentications might be performed. As described in detail herein, the customer may authenticate to the bank. Also, in accordance with one aspect of the invention, the bank may authenticate to the customer. For example, with reference to FIG. 1, the customer gives the bank a coordinate (e.g., B-3) and (in response) the bank tells the customer “Card value at location is 720”. This authenticates the bank to the customer. Further, there may be a wish to use different parts of the card. For example, if the bingo card has single digits at each coordinate the customer might be asked to report several starting at a given location, or be told the values of several so as to further authenticate. The bank may perform some transformation on the number at the particular location, e.g., such as adding one to the number, i.e., such that the bank would respond with the value 721 in the above example.

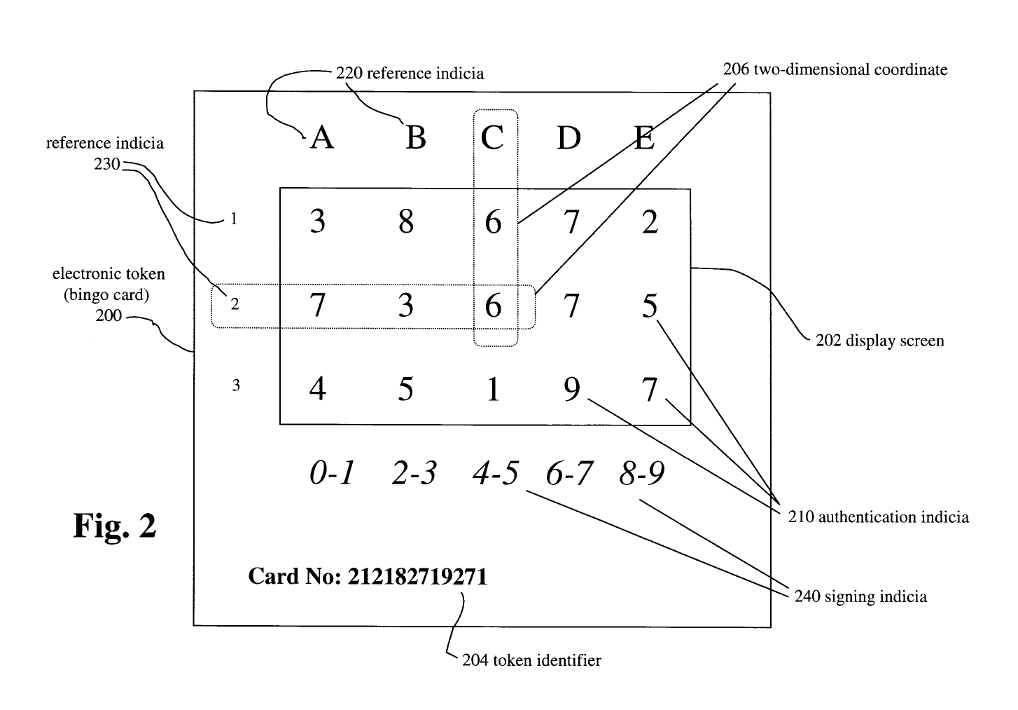

In further explanation, FIG. 2 is a diagram showing an electronic token or bingo card 200 in accordance with one embodiment of the invention. The electronic token 200 includes a display screen 202. The display screen 202 generates authentication indicia 210, which are disposed in a plurality of rows. The authentication indicia 210 may be numbers, letters, or any other character. The authentication indicia 210 may be generated by the display screen 202 in any suitable manner, such as an LCD screen.

While not needed, the electronic token 200 of FIG. 2 also includes reference indicia 220 and reference indicia 230. The reference indicia (220, 230) define two-dimensional coordinates on the electronic token 200. Particular two-dimensional coordinates, i.e., a respective coordinate from the reference indicia 220 and the reference indicia 230 are then used to identify particular authentication indicia 210. For example, the reference indicia (C-2) are used to identify the authentication indicia 210 “6”, i.e., the number 6. If reference indicia was not provided on the card, the customer would have to count the rows/columns, e.g., count in three rows.

The electronic token 200 of FIG. 2 shows the reference indicia (220, 230) as being permanently printed on the electronic token 200. However, the reference indicia (220, 230) may also be generated by the electronic token 200 using a suitable display.

Two-dimensional coordinates may be used to call out a single character or a series of characters, for example. The customer and/or the authenticating entity may then report to the other a character, a string of characters starting at a particular coordinate or a part of a string of characters, for example. In implementation of the invention, any character might be used as authentication indicia, and it is not needed that numbers be used in the bingo card (i.e., token). That is, any of a wide variety of graphics, letters, symbols, glyphs, runes, images or other indicia, for example, might be used in lieu (or in combination) with numbers so as to constitute authentication indicia. Accordingly, any such authentication indicia may be used to constitute a PIN (personal identification number) as described herein.

In accordance with one embodiment of the invention, the customer may authenticate to the bank. For example, a bank can give a starting location and ask a customer to report several positions from numbers on the bingo card starting at some coordinate the bank gives. Thus, the bank might tell customer “start at position C2 and report the digits in the order you specified” That is, the customer has previously selected (or been informed by the bank) of a particular order of digits to report. For example, the customer might have decided to report the 5th, 1st, and 3rd digits. The value starting at C2 (as shown in FIG. 1) is 380908. Thus:

The 5th digit is 0;

the 1st digit is 3; and

the 3rd digit is 0.

Thus, the customer reports “030” and is authenticated. This proves (1) the customer as an individual is present (2) and that the customer has the token 10. In accordance with embodiments of the invention, the operations described herein may be utilized with an electronic token (having a dynamic or a static display), as described above with reference to FIG. 2. The invention also relates to use of a preprinted token, as depicted in FIG. 1. With printed material, it might be the case that further variations in the selection are possible, with such material, i.e., because pre-printed material typically has more capacity for a large amount of text (and the varied positioning of such text) versus an electronic display.

That is, while the selection of digits at a position in a short electronic display is rather limited, on a preprinted card the selection can be done across, down, diagonally, backwards, or in other permuted ways which are not significantly different to compute and validate remotely, but which will appear different to a customer. Likewise some operations can be easier with a printed card versus an electronic display. For example, if an authenticating entity tells a customer with an electronic display to add some constant (that he recalls from memory) to part of the electronic display, a human can do this but the result will be error prone. Telling the same human to please count over “n” cells before picking digits to report might however be easier with a printed card, (and not much harder if you ask the customer to pick a direction to move in (up, down, left, right, diagonally, etc.) as well). Thus, where “simple transforms” are mentioned, these may be feasibly drawn from a larger universe of operations with preprinted cards, than is available with electronic tokens, or some other type of electronic display.

As described herein, embodiments of the invention use the underlying principle of using a selection of a number from a two-dimensional token and applying a human operation on that number to derive an authentication value to report. The application of such to preprinted cards is (as described herein) novel vis-à-vis schemes seen in the industry. It appears that it is not fashionable to ask people to do simple operations, and so the conventional approach has people typing in PINs (in places that can be detrimentally observed) or using tokens with no protection when they are stolen. Rather, as seems to be the trend in the industry, the apparent fashionable replacement is a smart card plus lots of extra hardware. In contrast, by using human “smarts” in embodiments of the invention, the same certainty of authentication is attained at much less cost and complexity. The systems described here also can work with unmodified or almost unmodified payment networks, since the messages used in the invention are short and can be used instead of pre-existing inputs that are now commonly asked for.

In accordance with one embodiment of the invention, the amount of a transaction may be signed. While an authenticating institution may use the above described scheme such that both parties are each assured they know initially the identity of the other, but if a connection is hijacked (which can be done via malware in a computer or via other methods), transactions done moments later with the connection may nevertheless be unauthorized. Therefore, it is desired (in some situations) to have a way for a customer to further authenticate a transaction (referred to herein as “signing” it) at its end. In accordance with one embodiment of the invention, this can be done as described below.

With a variable display device (such as shown in FIG. 2), when the transaction is done, we can use the authentication indicia on the display to have a customer verify things about the transaction. Such authentication involves the use of the signing indicia 240 provided on the electronic token 200. For example, a customer could select positions on the display corresponding to the transaction amount. With reference to FIG. 2, suppose the total amount of the purchase is $285, and that the authenticating entity tells the customer to “Use Row 3”. The customer can select positions based on the italic labels:

2 is one of group “2-3” and the display digit above that (in row 3) is 5;

8 is one of group “8-9” and the display digit above that (in row 3) is 7; and

5 is one of group “4-5” and the display digit above that (in row 3) is 1.

Thus, the customer reports “571” to the bank, and is seen by the bank to validate selection of the $285 total amount. Further, the customer could perform some type of transform on the string “571”, e.g., such as a re-order of the numbers, and then report such re-ordered numbers.

In accordance with one embodiment of the invention, this operation is performed on the net via a suitable computer system. In such an operating environment, detailed instructions can be provided to the consumer (to minimize customer questions.) This approach shows the card is used and that the consumer with the card has signed off on the amount, i.e., the same card that was used shortly before to authenticate the customer as an individual is subsequently used to sign off on the amount. This approach makes man in the middle attacks much harder.

With a bingo card as described herein, the customer can be given a coordinate from the bank, and use that as the start of a display number. Thus, with reference to FIG. 1, the bank says “start at A4, and to validate $285, pick the 2nd, 5th, and 3rd digits”. Customer would see that the numbers at (A4, A5) are 186 327, and would pick 8 2 6 out and report that. This would “sign” the amount since the customer is directly responding to the bank (in response to the bank posing the amount) with information that only the customer with the card would know.

Aspects of the invention are described above relating to a token that displays indicia in some predetermined manner and content. The preprinted card usage may be very much like the usage for the display token. However, while the principle may be the same, some of the details of selection may differ.

One motivation for suggesting printed “bingo cards” (as characterized herein) instead of electronic tokens is that printed bingo cards are cheap and technically uncontroversial. Attacks on the printed bingo cards described herein may be avoided by the cards being changed frequently.

With an electronic token, e.g., an electronic bingo card as described herein, the authentication indicia may be generated in any suitable manner, as should be appreciated by one of ordinary skill in the art. For example, the authentication indicia may be generated using an internal counter encrypted with a key. Typically, a different key should be used for every device. The authenticating agency needs to know the keys but nobody else does.

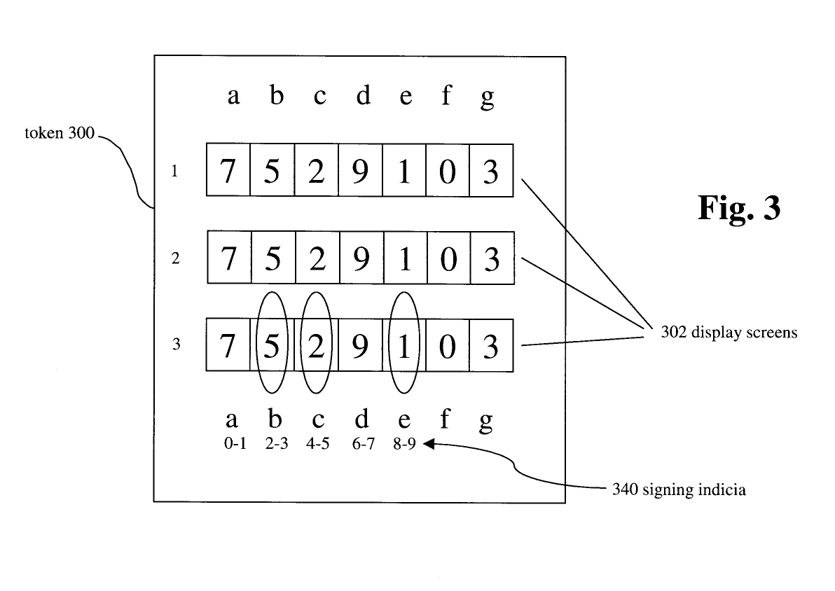

FIG. 3 shows a token 300 in accordance with one embodiment of the invention. The token generates a display using the display screens 302, as shown. The display 302 displays authentication indicia. A series of letters “abcdef” is set out below and above the display. Numerical digits “123” are sequentially set out to the left of the display 302, as shown. The letters and the digits provide reference indicia. Further, the token 300 includes signing indicia 340, described below.

In this scenario, the customer is asked, ahead of time, to pick three positions of the display such that indicia in the display might be read by the customer in a pattern. For example, customer might use three letters to remember the pattern, i.e., such as the letters “feb”. The pattern may be selected as desired, however, some will choose to spell things for ease of memory. Further, based on a predetermined arrangement, the customer will read the numbers from a predetermined row 1-2-3, or alternately, be advised of which row to read from. For example, the communications from the authenticating entity to the customer might advise the customer which row to read from.

In order to identify himself and his token, a customer would prompt the token (e.g., through pressing a button on the token) to generate a number, then pick out the digits at the positions he selected, in the row he selected. In the above example, the customer picked the positions “feb”. Further assume the customer picked row “3”. As a result, such positions, i.e., such pattern in row 3, corresponds with the displayed digits 0 1 5.

In this example, the display of the token changes every time. Accordingly, the digits called out by the customer, i.e., the chosen digits, will be different every time. Using this approach, the user and the token are authenticated together in a single stroke. Further, the characters displayed by the token are hard to capture because (1) the token is not connected to anything, and (2) the token may well not be in range of a webcam or other spy gadget. Note too that the customer giving the authentication information is a conscious act, not something a chip can be fooled into doing.

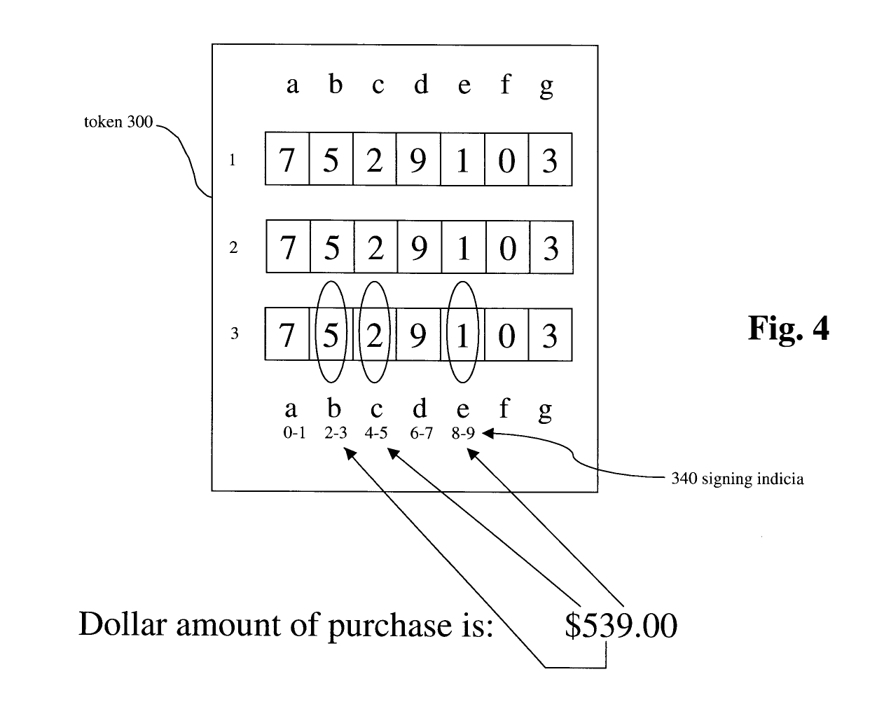

FIG. 4 is a diagram showing the token and same display as FIG. 3. However, FIG. 4 shows a different use relating to verification of a monetary amount. Where a transaction involves a monetary amount, it may be desired to secure the customer's authorization for the particular amount. In this situation, the customer may be asked to pick the displayed digits above the signing indicia 340 in a particular row, as shown in FIG. 4. That is, if it is desired to get a person's OK to spend, say, $539 on something, he could be asked to pick the positions above the signing indicia 340 that correspond to 539 on his display, and be told to pick them from row 3 of the token 300. As shown in FIG. 4, the customer would thus pick the “45”, the “23”, and the “89” positions, and if the display read as shown the customer could key in “251” to give his OK of the dollar amount. This type of authentication would likely be most important for large purchases and in internet type settings, for example.

The above processing would provide very good authentication relative to current known techniques. Also, the same networks that are currently used in the US could support the above described authentication. That is, credit card/debit card authentication codes are 3 digits long, for example. Such authentication also may well be preferred to (and used in lieu of) a fixed PIN.

The printed bingo card described herein provides a relatively cheap and straightforward implementation of schemes described. The “bingo cards” may be prepared and sent out by an authenticating agency (or an entity acting on behalf of an authenticating agency). In accordance with one embodiment of the invention, each bingo card is made of suitable material, upon which authentication information is printed, e.g. such as paper or plastic. Each bingo card may be different in terms of the specific authentication information set forth thereon. Further, each bingo card typically possesses identifying indicia of some nature, i.e., such as a serial number.

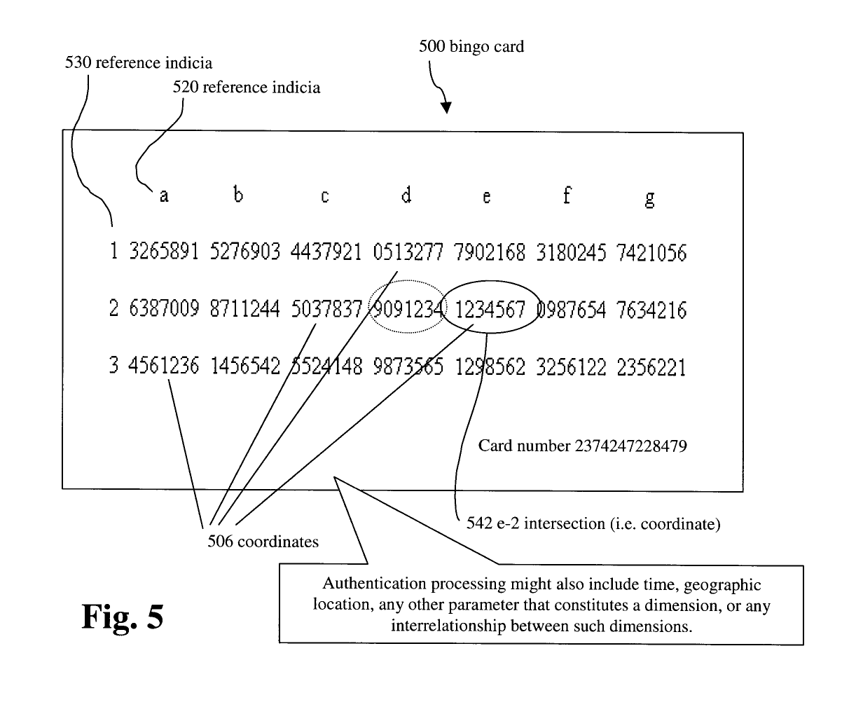

FIG. 5 shows a bingo card in accordance with one embodiment of the invention. It is appreciated that there may be many variants of the bingo cards described herein. For example, the numbers may be shorter or longer. Further, it is not needed that numbers or letters be used. That is, any indicia might be used in lieu of (or together with) numbers or letters so long as information derived from the indicia may be communicated from the customer to the authenticating entity.

In the example shown in FIG. 5, the bingo card 500 includes reference indicia 520 and reference indicia 530. In the example shown, the reference indicia 520 includes letters a-g, while the reference indicia 530 includes numbers 1-3. However, the bingo card 500 may use any suitable indicia for the reference indicia (520, 530). Further, the reference indicia (520, 530) may be arranged vertically, horizontally, or in any other suitable manner.

The reference indicia (520, 530) define coordinates 506. In a simple form of the bingo card 500, a number is disposed at each coordinate, and in the example of FIG. 5, a seven digit number is disposed at each. Thus, the bingo card 500 of FIG. 5 might be characterized as including seven digit numbers disposed in a two-dimensional array. However, as described herein, the various embodiments are not limited to utilizing two-dimensions.

In accordance with one embodiment of the invention, the customer requests a transaction, such as the purchase of a product. In this example, it is desired that the authenticator wants to prove to the customer who the authenticator is. To effect this authenticator confirmation, the customer sends the authenticator coordinates from the bingo card 500, e.g. row and column coordinates using the reference row 520 and the reference row 530, respectively. In response, the authenticator conveys the particular value (authentication indicia) at the named coordinates.

In the transaction, the customer also authenticates himself to the authenticator. In accordance with one embodiment of the invention, the customer has previously picked a pattern (or been informed of a pattern that was selected by the authenticating entity). This pattern may be selected as desired. For example, the pattern may be a particular sequence of numbers that is selected upon initiation of the account and/or issuance of the bingo card 500.

In the process of customer authentication, the authenticating entity provides the customer with particular coordinates. For example, the authenticating entity might provide the customer with the coordinates e-2. In response, the customer looks to the particular coordinates e-2 on his or her bingo card 500. In this example, the customer sees the number 1234567 at the e-2 coordinates. The customer then applies his previously selected pattern to this number.

That is, for a customer to authenticate himself, the customer picks a pattern to select out of a provided display, and the authenticator gives the customer the coordinates to use. The customer then picks out his selected pattern of 3 or 4 positions, for example, and reports the resulting digits.

In the illustrative bingo card of FIG. 5, say the pattern selected was the 6th, 5th, and 2nd digits, and the bank or other authenticating entity gave the customer the coordinates d-2. The customer would then apply the pattern to such number (9091234) and pick the numbers 3 2 0 and report “320”.)

In accordance with one embodiment of the invention, the bingo card is provided such that the customer “scratches off” a particular coordinate or coordinates that are disposed on the bingo card. In use of such a card, the authenticator might be able to track what coordinates the user scratched off and which were not scratched off. For example, such information regarding which coordinates were scratched off and which were not scratched off might be obtained through observation by a merchant or through some type of mechanism in the card itself If a mechanism in the card itself is used, such might include conveying information back to the authenticating entity via the network used in processing the transaction. Accordingly, this implementation using scratch off numbers might be most useful for network authentication where some added communication is easy.

If one was asked to approve an amount string or the like with a bingo card, it might be easiest if the user got prompted first (e.g. with a picture of what digit positions to pick out and with what coordinate). The user would be able to see the digit pattern and check that it was reasonable. However, one who did not have the user's (customer's) card, and had not authenticated himself with the pattern moments before, would not get that far with the transaction. In general, the user may be “coached” in any suitable manner such as prompting and/or cueing the user (either visually or otherwise) as to what action to take (including where on the card to look).

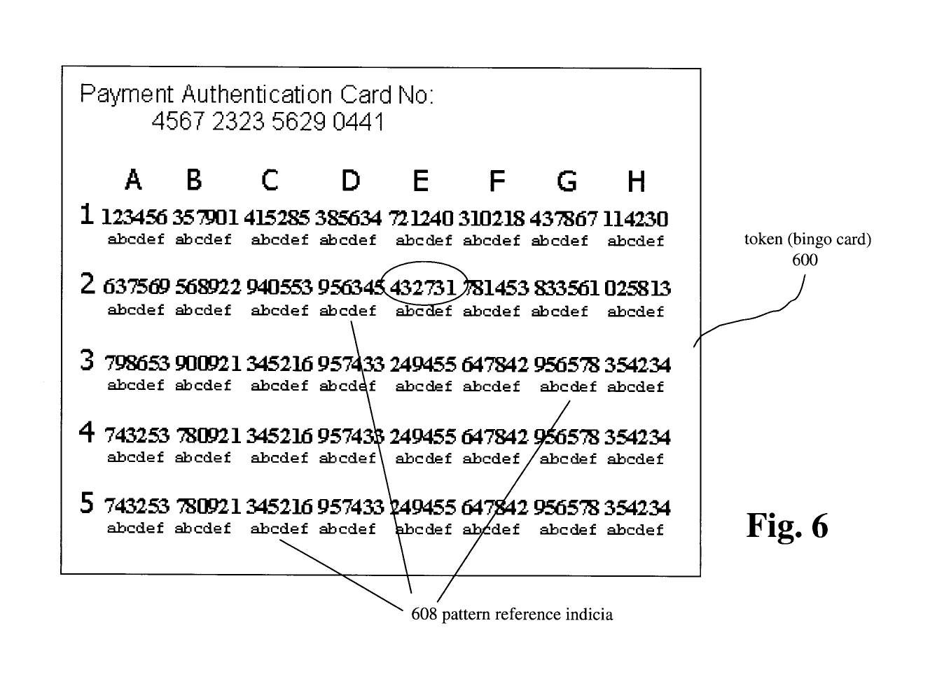

FIG. 6 shows a further token 600 in accordance with one embodiment of the invention. The token 600 further shows how a pattern might assist in the customer performing the transform on the characters (disposed at named coordinates). That is, the token 600 includes reference indicia 608 associated with the authentication indicia. In this example, assume the authenticating entity tells the customer to use cell E-2, i.e., coordinate E-2. Further, the pattern that the user knows to report is “b f e”. The cell, i.e., coordinate, E-2 contains the characters (i.e., the authentication indicia) “432731”. Thus, using the customer pattern b f e, the customer reports “3 1 3” to the authenticating entity.

As described above, the amount of a transaction, e.g. the dollar amount, may be verified by the customer. It is appreciated that various other information may be verified by the customer. For example, the customer might be presented with any information and then asked to confirm such information using the schemes described herein. The confirmation of the information may include the customer referring to a number at a particular coordinate (or coordinates) of the bingo card and applying the customer's known pattern to such number. For example, variants could be used to check payee names if the need should arise.

The beauty of schemes like this, while they are a little more effort than some, is they need only simple devices. They utilize the fact that the devices are not connected to anything that can have wiretaps, hostile programs or other covert observation systems attached. Further, people are relatively adept at remembering simple patterns. Further, the bingo card would typically be used often enough that the pattern picked would not be a problem to recall. The customer might be provided with several bingo cards and use the same position pattern for all of them. If a random display is used, such random display further adds to the difficulty in performing fraudulent transactions.

As described above, (1) the bank (or other authenticating entity) may authenticate to the customer, (2) the customer may authenticate the customer's identity to the authenticating entity, and/or (3) the customer may authenticate the amount of the transaction, i.e., sign off on the dollar amount. In order to simplify the processing of transactions, some sites (or other point-of-sales) might omit authentication of the bank and/or authentication of the amount. However, even such limited authenticating may well be sufficient for many transactions. As long as the coordinates of the card being used are distributed over the entire set available, repeated values will be uncommon and difficult for a thief to use, even if other parts of the path to the authenticator are wiretapped. In other words, typically, the authentication scheme should not use the same pieces of the image (e.g. the same two or three numbers on the card) time after time with no change. Rather the areas of the image, e.g. the card, that are picked (to authenticate with) should be varied.

The invention provides an authentication scheme that is highly usable by people and that is voluntary and conscious. The invention is seen to provide advantages over various other authentication schemes. For example, fingerprints can be stolen in ten seconds with tape. In general biometrics must be kept un-stolen for around 100 years—a long time in light of the extensive exposure of one's biometrics. RFID might be read without the customers knowledge, much less consent.

In accordance with one embodiment of the invention, a number of bingo cards might be used in some transactions. Each bingo card might authenticate the customer's relationship to one authenticator. In effect, such multiple authenticators could act like a “web of trust” by which the customer shows “I am a customer of x bank, y bank, z company, and a member of r and s clubs”. Such multiple authentications might be used if the customer is requesting an on-going line of credit from a bank or merchant, for example.

As described above, a pattern is either selected by customer (and conveyed to the authenticating entity) or selected by the authenticating entity and conveyed to the customer. The pattern will thereafter be the customer's pattern to use in authenticating. The pattern should of course be communicated between the authenticating entity and the customer separate from the bingo card or token, i.e., in a separate mailing, for example.

The invention as described herein uses a simple operation on a “random” (actually, pseudorandom) number or numbers which can be obtained on a token or can be preprinted on a card. Thus, the invention includes the use of an operation on the number or numbers to provide further information which validates the identity of a person (and not just of a token) and/or which can validate the acceptance of attributes of a transaction (e.g., the total amount to be paid).

In some embodiments, because the underlying numbers (i.e., the coordinates of the bingo card that are used) variously changes, the results of the second operation are also varied. This makes it difficult to fake the identification, even if an evildoer can observe the numbers (or possibly letters or other glyphs or any other character) being transmitted. Because the token or preprinted matter here is not connected to anything that can be wiretapped or surreptitiously traced in any simple way, the selection portion (or other second operation) remains available only from the customer's memory. This makes the scheme a good authenticator.

With the prevalence of remote cameras or wiretaps in ATM machines which can record PINs easily, it is clear that something used as an authenticator should not be easily observed by any such device. This device satisfies this need, and when the numbers are preprinted, there is no technical barrier to deploying them. This invention shows how a single short response can provide multiple pieces of information. Moreover a 3 or 4 digit response, for example, can be used in payment networks currently in place which use 3 and 4 digit authenticators for credit card validation values or customer PINs respectively. This invention proposes authenticators which change with use and which in the proposed system are not easy to steal even in rather insecure networks. The scheme also can identify to the customer the identity of merchant or bank which issued the token. This combination of features provided by the invention provides for an effective and efficient authentication scheme.

Accordingly, a system is proposed which allows multi-factor authentication and transaction “signing” in connection with tokens which may be preprinted and unique. By using a simple user operation on numbers from the token, it produces authenticators which can change with each use, are small enough to use instead of existing PINs and the like, and which are almost impossible to steal even on a wiretapped network.

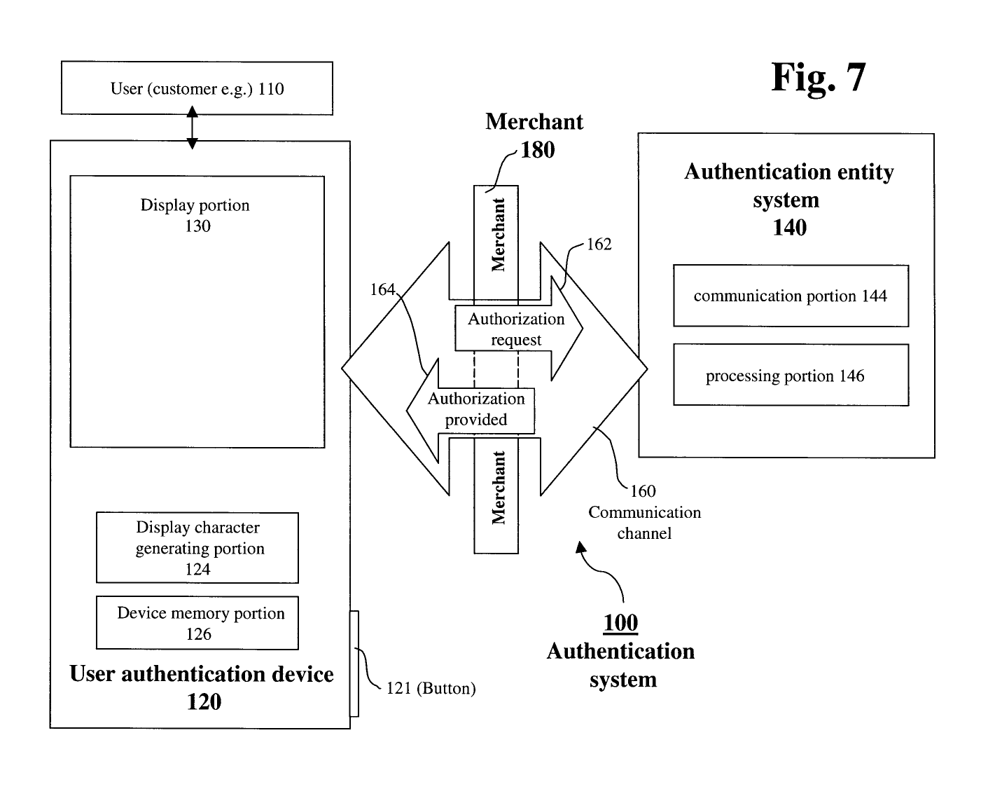

It is appreciated that a wide range of architectures may be used in implementation of the invention described above. FIG. 7 is a block diagram showing an authentication system 100 in accordance with one embodiment of the invention. The authentication system 100 includes a user authentication device 120. The user authentication device 120 may be in the form of a token, for example. The user authentication device 120 provides the user with display characters (as described above) that are used by the user to effect an authentication.

As shown in FIG. 7, the user authentication device 120 includes a display character generating portion 124 and a display portion 130. The display portion 130 may be used to provide any of the displays as described above.

The display character generating portion 124 generates the characters that are displayed in the display portion 130. In particular, the display character generating portion 124 uses predetermined logic (i.e., a suitable algorithm) to populate the display. This logic provides a predetermined progression of numbers, or other characters, that may be similarly generated by an authentication entity system 140, as shown in FIG. 7. That is, through suitable processing, the authenticating entity performs processing in parallel to the manipulation of information performed by the customer as described above, i.e., so as to authenticate the customer. As shown in FIG. 7, the authentication entity system 140 includes a communication portion 144 and a processing portion 146. The communication portion 144 provides for communications between the authentication entity system 140 and the user authentication device 120 and merchants that participate in a transaction of the user 110. The processing portion 146 handles the various processing of the authentication entity system 140, as described herein.

In accordance with one embodiment of the invention, the user authentication device 120 has a button 121, which may be pressed by a user 110. Upon pressing the button 121, the display character generating portion 124 generates the characters that are displayed in the display portion 130. Accordingly, the user 110 interfaces with the user authentication device 120 using the button and visually, in accordance with one embodiment of the invention.

The user authentication device 120 further includes a device memory portion 126. The device memory portion 126 serves as a memory or database, as is needed to perform the various functions of the user authentication device 120.

As shown in FIG. 7, the authentication system 100 also includes an authentication entity system 140 and an illustrative merchant 180. Illustratively, the user 110 (using the user authentication device 120) interfaces with the merchant 180 so as effect a desired transaction. The transaction might be over the telephone, the Internet, or any other communication channel, as desired.

Accordingly, the systems and methods of embodiments of the invention may be used in any “transaction”, including a conveyance of information, in which authentication of a user is needed or desired. Such transaction might include a telephone transaction, Internet transaction (such as an Internet purchase), network transaction, infrared transaction, radio signal transaction, credit card transaction, debit card transaction, smart card transaction, ACH transaction, stock trade transaction, mutual fund transaction, swap, PAYPAL® transaction, BILL ME LATER® transaction, electronic funds transfer transaction, financial application transaction, an arrangement to set up payments to an entity, a verification, an ATM transaction, and/or a message, for example. For example, such a transaction might include a message from one human user to another human user, a human user communicating with an electronic device, and/or two electronic devices communicating with each other. The transaction may or may not be in a financial context, i.e., a “financial transaction.” For example, the message might be authorizing the opening of a door or the transfer of a non-financial related message, for example.

Accordingly, FIG. 7 shows a communication channel 160 over which the transaction is performed. The communication channel 160 carries an authorization request 162. Subsequent to the request being processed by the authentication entity system 140, the communication channel 160 then carries an authorization 164, in the example of FIG. 7. However, it is of course appreciated that the authentication entity system 140 might alternatively not authorize the requested transaction. As shown in FIG. 7, the authorization request 162 and the provided authorization is passed through the merchant 180. However, in an alternative embodiment, the authorization request 162 and/or the authorization provided 164 might be communicated to the authentication entity system 140 in some other manner, such as by some third party, and not via the merchant 180; or indeed directly from the customer to the authenticating entity. Further, it is appreciated that the user authentication device 120 need not take on the form of the device shown in FIG. 3. That is, for example, the user authentication device 120 might be in the form of a software program running on a computer, or in some other alternative form.

As shown in FIG. 7, one communication channel 160 is utilized. However, it is appreciated that multiple communication channels could also be used. That is, for example, a separate communication channel might be used for a portion of the authentication. In particular, it is noted that it is much harder to spook on two channels. Thus, any of the authentication communications described herein may be broken up so as to be sent on two (or more) channels.

The invention is described above in the context of using two dimensions. However, the features described above could also be applied to three-dimensions (or more), so as to practice the invention. Such might be particularly applicable to practice using an electronic display.

That is, any number of “dimensions” might be used in the practice of the invention. The “dimensions” used might be based on spatial dimensions (such as the two-dimensional arrangement described above and/or a three-dimensional arrangement), time, geographic location, any other parameter that constitutes a dimension, or any interrelationship between such dimensions. For example, an interrelationship between dimensions might be that in the AM hours of a day a first two-dimensional coordinate is used by the customer and in the PM hours a second two-dimensional coordinate is used by the customer. Thus, for example, with reference to FIG. 5, the customer might use the number at -1a- (3265891) in the morning, but use the number at -2f- (0987654) in the afternoon. In a similar manner, the coordinates (or other dimension used) might vary with the geographic location at which the customer is located. This would of course involve the authenticating entity identifying such geographic location. In summary, embodiments of the invention might use any number of dimensions and any interrelationship (i.e., interplay) between such dimensions.

As described above, a user authentication device might be in the form of a software program running on a computer, or in some other alternative form. Hereinafter, further embodiments of the invention are described. In this example, a picture, image (or other display) is displayed on a computer, PDA, cell phone or other suitable display device instead of a printed bingo card.

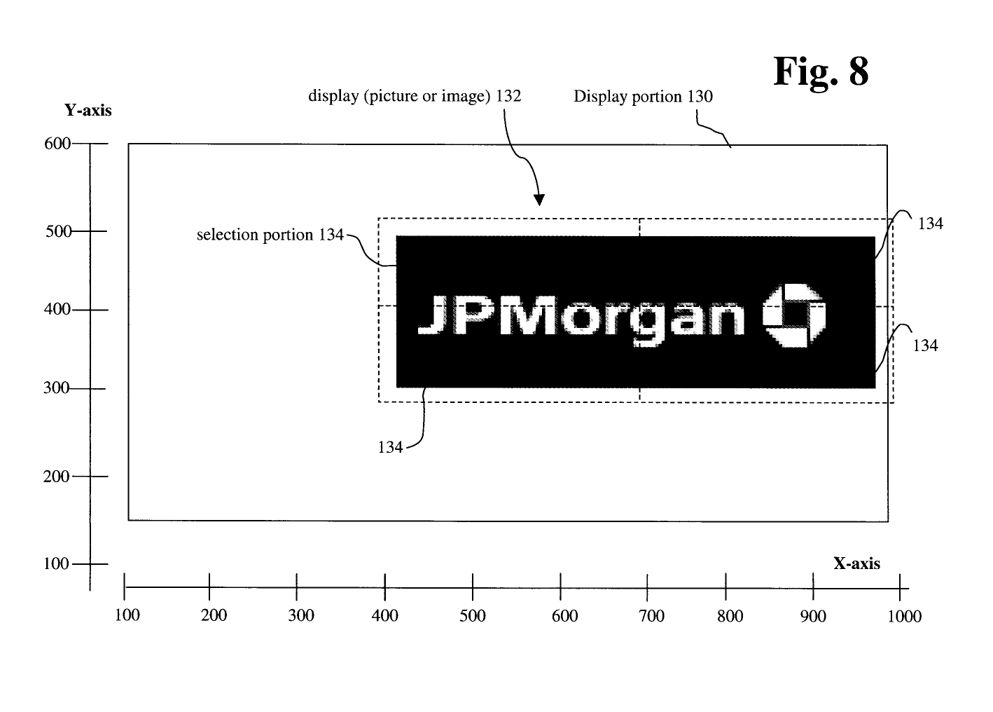

The problem that the embodiments of FIG. 8-10 address (as described below) is again directed to establishing someone's identity (or assent to some transaction) over a wire where the path between the authenticating entity (e.g. a bank) and the person (e.g. a customer or other user) may be tapped or watched (and possibly otherwise interfered with).

In this vein, many thieves take advantage of the difficulty in establishing identity and one problem is that many customer PCs (personal computers), or other electronic devices, which are used to enter information have software backdoor programs on them. These software backdoor programs are installed by thieves by means of various subterfuges. Such software backdoor programs permit observation of anything in the PCs and may even allow remote control of the PC.

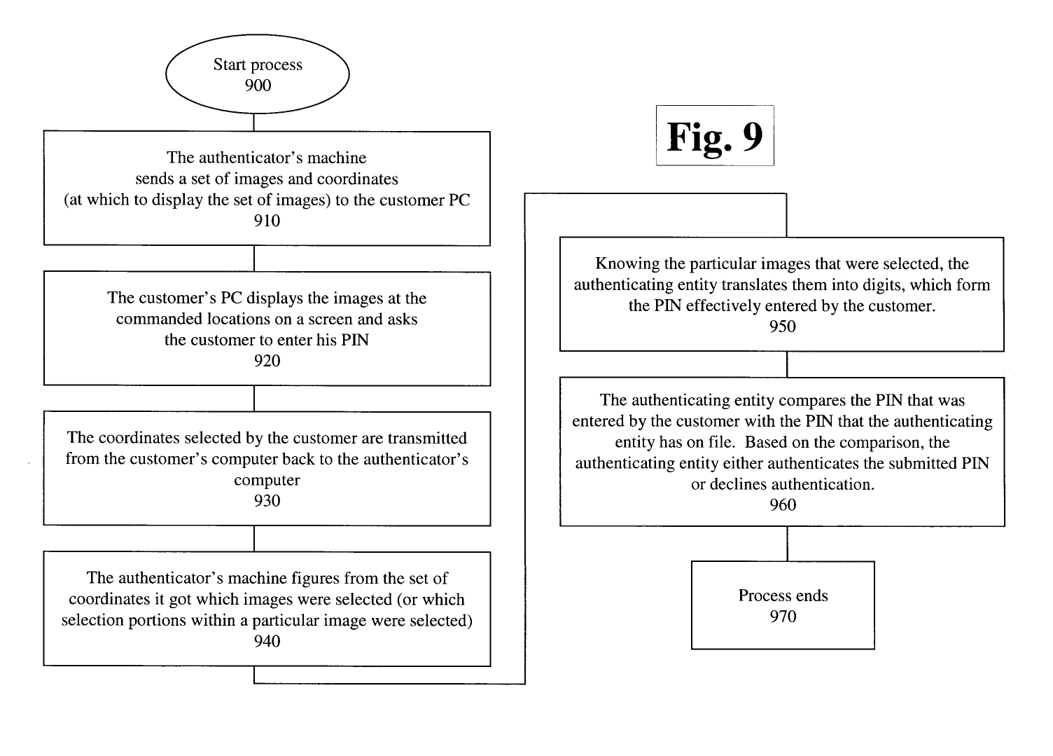

In the embodiments described below (with reference to FIGS. 8 and 9) is a method by which a person can transmit information to the authenticator in a way which makes it exceedingly difficult for any software backdoor or other surveillance programs to decode. In particular it ensures that the values being sent do not exist in any readily decodable form anywhere in the PC, nor on the wire.

In accordance with this embodiment of the invention, a display is presented to the customer working on their computer. The display may be in the form of an image or picture. The display can be varied from customer to customer and/or from instance to instance for a particular customer, e.g. from transaction to transaction. FIG. 8 shows the display portion 130 of FIG. 7. A display 132 is presented to the customer on the display portion 130.

In accordance with one embodiment of the invention, the display 132 is in the form of a picture or image that includes “selection portions” 134 as characterized herein. The term “selection portion” means that in the display (presented by the customer's computer to the customer) includes demarcated sections, i.e., selection portions, that the customer may identify. The demarcations between the selection portions may be readily obvious to the customer based simply on viewing the image, or alternatively, the demarcations between the selection portions 134 may be based on the customer's knowledge instead of the display 132 itself.

In one straightforward embodiment, the display may simply include a grid with numbers disposed in each box in the grid, i.e., such that the customer may choose a particular box in the grid. This is an example of a display in which the demarcations between the selection portions are readily ascertainable by simply looking at the display. However, the display may take on any form such that the customer can select a particular part of the display. For example, the display 132 of FIG. 8 is simply the “JPMorgan” logo. However, in this example, the customer knows that the selection portions are respective quarters of the display, as shown in FIG. 8, and shown by dashed lines (the dashed lines are for illustration only and would not actually be seen on the display presented to the customer). Thus, the customer knows to click (or otherwise select) particular quarters of the display 132 in a particular order, i.e., so as to constitute authentication indicia, e.g., the equivalent of a PIN. For example, the customer's authentication indicia might be:

top-right;

top-right;

bottom-right; and

top left.

Accordingly, selection portions (which constitute a customer's PIN, for example) may be used which are easy for customers to remember. In order to avoid having the selection portions be analyzable by “backdoor” code on the particular electronic device (computers, cell phones, PDAs, etc.) the display may be varied in position on the customer's device and/or varied in content. The display may be generated and displayed as an image or picture, as noted above, as well as text fonts, or in any other suitable format. Such display may be engineered to make it difficult for software to pick out the information the customer would select. For example, the position of the display 132 might be varied on the customer's computer as desired. Further, in the example of FIG. 8, the particular picture might be varied. In this example, whatever picture is presented to the customer, the customer would know that the demarcation is based on quarters.

To further explain, in accordance with one embodiment, the authenticating entity generates the display and forwards the display to the customer's computer. As shown in FIG. 8, the display may be in the form of a picture, e.g., the JPMorgan logo. The customer then views the display 132. Based on the customer's review of the display 132, e.g., the picture presented on the screen of the customer's device, the customer sequentially selects an agreed pattern of “selection portions” on the display (or alternatively an agreed pattern of separate images on the display). For example, the customer might select the selection portions using a mouse or contacting a touch screen. Based on what selection portions the customer selected, i.e., the pattern selected by the customer, the customer's electronic device would then report the pattern, i.e., the series of selected positions, back to the authenticating entity. The selected positions might be in the form of coordinates on the customer's computer screen. For illustration purposes, FIG. 8 includes X-Y coordinates.

Once the authenticating entity receives the series of selected positions, the authenticating entity converts the selected positions to digits, letters, or other authenticating indicia. The authenticating entity then authenticates the converted information against what was expected, i.e., against what the authenticating entity has in their records. In short, the authenticating entity may compare the coordinates that were selected by the customer (using the coordinates that the authenticating entity knows the picture was displayed) and determine if the pattern selected by the customer is indeed what was expected for authentication.

For example, the authenticating entity transmits data to the customer computer indicating the display 132 should be displayed so as to be centered at the X-Y coordinates (700, 400) as shown in FIG. 8. Using the example pattern above, the customer then knows to select sections in the display 132 based on the sequence: top-right; top-right; bottom-right; and top left.

Accordingly, the customer might click on the coordinates: (900, 450); (900, 450); (900, 300); and (500, 500). These coordinates would then be sent back to the authenticating entity. The authenticating entity utilizes the information that the display 132 is centered at the X-Y coordinates (700, 400). From this information, the authenticating entity can determine where the coordinates, that were entered by the customer, are in the image. Thus, the authenticating entity determines that indeed the coordinates are in the top-right; top-right; bottom-right; and top left of the display 132. Since such selection, i.e., such pattern, is indeed what the authenticating entity is looking for, the authenticating entity authenticates the transaction.

FIG. 8 shows utilization of a single display that includes a plurality of selection portions. However, alternatively, multiple displays, i.e., multiple pictures or multiple images, may be used. The customer then selects from the multiple displays in some agreed upon order, i.e., sequence. Thus, the various quarters of the image of FIG. 8 might be four images instated of one image. A further illustrative case of a display would be to provide a digit pad in some suitable font onto the screen. The customer would then pick a number or a function of the numbers, as agreed upon between the customer and the authenticating entity.

It should be noted that a trusted secure module is available on some customer electronics devices. Such trusted secure module can be sent a seed number by the authenticating agency, and the data of the display can be delegated to such a secure module. As a result, the main processor (and backdoor code therein) will not be able to find the numeric or textual values being selected by the person being authenticated. One useful feature of such use is that the display presented to the customer has no clear text, in accordance with one embodiment of the invention, but rather is in the form of a picture. Any useful understanding by one having fraudulent intent is kept from the customer electronics device and is obscured by variations in position and detail. However, at the same time, the customer is given a simple and memorable pattern to enter. Generally, both the display details (e.g., the particular picture) and the customer pattern (i.e., what the customer selects) must be known by the customer to authenticate. The complexity of the details of the display, as well as the pattern that the customer selects, may be varied as desired.

The use of the scheme of FIG. 8 with customer electronics enables use of computers, cell phones, PDAs, and other electronic devices for data entry, even where such devices are subject to viral backdoor code being inserted upon them. This is true so long as the universe of displays is kept large enough and varied enough to make enumeration or simple feature analysis in backdoors infeasible. The variety of selections available should help customers find a pattern for selection which will be easy to remember and which will make interception and/or any useful understanding of the information very difficult.

In accordance with one embodiment of the invention, FIG. 9 is a flowchart showing a process of using the display with selection portions of FIG. 8. With reference to FIGS. 8 and 9, further aspects of the invention will hereinafter be described.

In accordance with this embodiment of the invention, the invention is designed to let a customer select a few digits of a PIN on his computer. To do this, as shown in FIG. 9, first the process starts in step 900. Then, in step 910, the authenticator's machine sends a set of images and coordinates (at which to display the set of images) to the customer PC (personal computer). These images may be in any suitable form (such as representations of digits) to select from, sent in random and changing order so that predicting their order of transmission is infeasible. Also, the coordinates for display may be random and changing, known to the authenticator's machine, but again not predictable.

After step 910 of this example, the process passes to step 920. In step 920, the customer's PC displays the images at the commanded locations on a screen and asks the customer to enter his PIN. In step 930, the coordinates selected by the customer are transmitted from the customer's computer back to the authenticator's computer.

The customer's computer thus has no idea what any of these coordinates mean and that information cannot readily be determined without analyzing the images. The images may be “CAPTCHA” style images so that decoding them will be hard for a program. That is, CAPTCHA (“Completely Automated Public Turing test to tell Computers and Humans Apart” is a type of challenge-response test used in computing to determine whether or not the user is human.

After step 930, the process passes to step 940. In step 940, the authenticator's machine figures from the set of coordinates it got which images were selected (or which selection portions within a particular image were selected). Then in step 950, knowing the particular images that were selected, the authenticating entity translates them into digits, which form the PIN effectively entered by the customer.

Then, in step 960, the authenticating entity compares the PIN that was entered by the customer with the PIN that the authenticating entity has on file. Based on the comparison, the authenticating entity either authenticates the submitted PIN or declines authentication. In step 970, the process ends.

Notice that in the process of FIG. 9, the customer PC can only learn the PIN entered by analyzing the images. This may be made as difficult as desired, just so long as the human customer can still figure out which selection portion to select, and do so in a particular sequence. To defeat attempts to capture small image portions for human analysis, the customer might also be asked to choose a small part of a much larger image also, while the overall scheme remains the same. This small part of a much larger image might be denoted by an “X”. In other words, one fraud technique involves procuring a screen shot of just the area around the curser where a user clicks—such that the area can be studied by a human to effect fraud. However, if the numbers are rather large, this fraudulent technique becomes much less effective. This is because the small area right around the curser will not be recognizable if the number (or other image/graphic is large enough). Rather, the small area right around the curser may simply be a solid color (if the image is large enough).

The invention, as described with reference to FIGS. 8 and 9, involves accepting inputs from a customer of information using encoding information sent to the customer's computer (or other suitable) device from a trusted back end system, where the customer knows the information he is sending, can understand the encoding being used, but where the encoding is not available at the customer computer or similar device in any readily identifiable form. Thus, what is transmitted is a function of the information that is presented to the customer, not the information itself, where the mapping from the information to the function is difficult to decode.

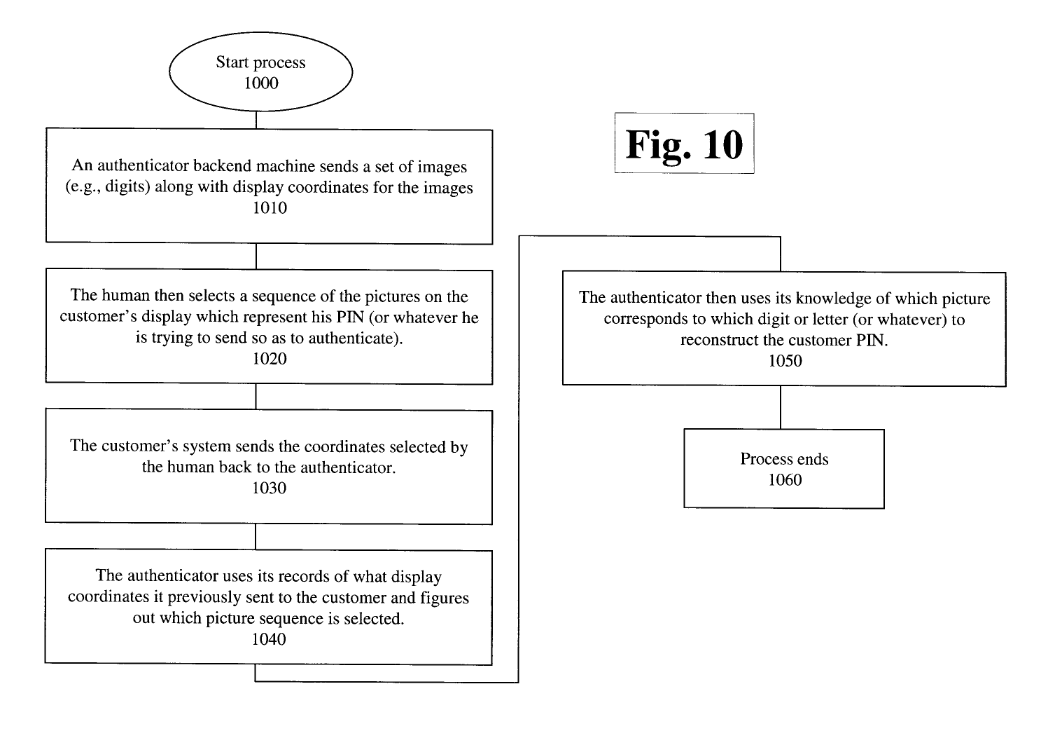

Hereinafter, further aspects of the invention will be described with reference to process shown in FIG. 10. In this embodiment, the process starts in step 1000. In step 1010, an authenticator backend machine sends a set of images (e.g., digits) along with display coordinates for the images. In this example, the set of images forms a “keypad” in some random order on a display at the customer premises. The customer premises is likely to be a PC, phone, PDA, or other suitable device. The images and position mapping may be provided to change every time, i.e., from one authentication to the next authentication, so as to further prevent fraud. The pictures may be as difficult to analyze as possible by software, though a human must be able to recognize them.

In step 1020, as shown in FIG. 10, the human then selects a sequence of the pictures on the customer's display which represent his PIN (or whatever he is trying to send so as to authenticate). If the customer prefers to remember something other than digits anything will do that he can recognize and find other than digits, i.e., such as quadrants as discussed above with reference to FIG. 8.). Then, in step 1030, the customer's system sends the coordinates selected by the human back to the authenticator. Then in step 1040, the authenticator uses its records of what display coordinates it previously sent to the customer and figures out which picture sequence is selected. In step 1050, the authenticator then uses its knowledge of which picture corresponds to which digit or letter (or whatever) to reconstruct the customer PIN. Then, in step 1060, the process ends.

Note that the value of the PIN appears nowhere in the memory of the customer's device at any time. Thus, the only way a backdoor program on the customer's device can decode what the customer is doing would be to decode the pictures. This can be made difficult by having many such pictures, or alternatively, a picture with many selection portions. Indeed, in some embodiments, if a fraudulent program intercepts the customer transmission back to the authenticating entity, the only information that will be intercepted is a series of coordinates on the customer's display.

As noted above, from transaction to transaction, the display and/or the particular position of the display may be varied. As a result, it is generally needed to keep track of which display (at which coordinates) was sent to the customer. It is also generally needed to keep track of what information was received back from the customer in response to the particular displayed image, i.e., what are the coordinates of the positions that the customer selected. The authenticating entity may keep track of this information in any suitable manner. For example, a web session ID might be associated with each piece of data associated with the particular interaction between the customer and authenticating entity.

As described herein, a single display (e.g., picture or image) might be used with multiple selection portions and/or multiple displays (e.g., pictures or images) might bee used. The coordinates of the display are then compared with the coordinates that the customer entered to determine whether the authentication should be granted. In accordance with one embodiment of the invention, it is also appreciated that layers of displays may be used. This arrangement, in effect creates a multiple dimensional authentication. In this embodiment, for example, a customer might be required to select particular locations on the display. Once the customer selects the commanded locations, a further display is presented to the user. That is, in order for the customer to even see the further display, the customer must select the commanded locations in the prior display. This may be done as many times as is desired. In accordance with one embodiment, information regarding the last display is sent back to the authenticating entity for final authentication, as described above. However, the particular amount of information that is entered by the customer, e.g., what coordinates the customer selected vis-à-vis the coordinates that the display was displayed, may be varied as desired.

As described above, FIG. 7 shows one embodiment of the system of the invention. The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above in the flowcharts. Such a set of instructions for performing a particular task may be characterized as a program, software program, or simply software.

As noted above, the processing machine executes the instructions that are stored in the memory or memories to process data. This processing of data may be in response to commands by a user or users of the processing machine, in response to previous processing, in response to a request by another processing machine and/or any other input, for example. Clearly, resistance to backdoor programs would require such programs to be in protected subsystem parts of processing machines so that their contents could not easily be read by intruding code. Such designs are becoming more commonplace both in computers and cell phones.

As noted above, the processing machine used to implement the invention may be a general purpose computer. However, the processing machine described above may also utilize any of a wide variety of other technologies including a special purpose computer, a computer system including a microcomputer, mini-computer or mainframe for example, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the process of the invention.

It is appreciated that in order to practice the method of the invention as described above, it is not necessary that the processors and/or the memories of the processing machine be physically located in the same geographical place. That is, each of the processors and the memories used in the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, or any client server system that provides communication, for example. Such communications technologies may use any suitable protocol such as TCP/IP, UDP, or OSI, for example.

As described above, a set of instructions is used in the processing of the invention. The set of instructions may be in the form of a program or software. The software may be in the form of system software or application software, for example. The software might also be in the form of a collection of separate programs, a program module within a larger program, or a portion of a program module, for example The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications and equivalent arrangements.

1. A method for authenticating a financial transaction using a display on a customer device, the method comprising:
outputting, by at least one computer processor to a touch-sensitive display, at least one image comprising a plurality of coordinates;
receiving a plurality of selected coordinates from the touch-sensitive display, each selected coordinate representing a coordinate from the at least one image that the touch-sensitive display sensed to be physically contacted by the customer;
the at least one computer processor determining whether to authenticate the customer by comparing the plurality of selected coordinates to a plurality of stored coordinates associated with the customer; and
the at least one computer processor outputting the authentication determination to the touch-sensitive display.

2. The method of claim 1, wherein the touch-sensitive display comprises one of a computer monitor, a PDA screen and a cellular telephone screen.

3. The method of claim 1, wherein the at least one image comprises a plurality of selection portions, and each of the plurality of selection portions is associated with one of the plurality of coordinates.

4. The method of claim 1, wherein the at least one image comprises a picture.

5. The method of claim 1, wherein the at least one image comprises a table with a plurality of numbers disposed in the table.

6. The method of claim 1, wherein the at least one image comprises a plurality of images.

7. The method of claim 1, further comprising:
identify a pattern from the plurality of selected coordinates; and
determining if the identified pattern is an agreed upon pattern.

8. The method of claim 7, wherein the selected coordinates comprises a sequence of coordinates.

9. The method of claim 8, wherein the coordinates are in the form of X-Y coordinates.

10. (canceled)

11. The method of claim 1, wherein the coordinates are in the form of X-Y coordinates.

12. The method of claim 6, wherein a plurality of images are selected, and the determination of whether to authenticate the customer further comprises comparing a sequence in which the plurality of images are selected to a stored sequence.

13. (canceled).

14. The method of claim 1, wherein the authentication is performed in connection with at least one of a purchase of an item and the purchase of a service.

15. A system that authenticates a financial transaction, the system interfacing with a display on a customer device, the system including:
at least one computer processor;
a touch-sensitive display; and
a processing portion comprising a non-transitory computer program that performs the following:
display, on the touch-sensitive display, at least one image comprising a plurality of coordinates;
receive, from the touch-sensitive display, a plurality of selected coordinates each selected coordinate representing a coordinate from the at least one image that the touch-sensitive display sensed to be physically contacted by the customer; and
compare the plurality of selected coordinates to a plurality of stored coordinates associated with the customer;
determine whether to authenticate the customer based on the results of the authentication determination; and
output the results of the authentication determination on the touch-sensitive display.

16. The system of claim 15, wherein the at least one image comprises a plurality of selection portions, and each of the plurality of selection portions is associated with one of the plurality of coordinates.

17. The system of claim 16, wherein the at least one image comprises a picture.

18. The system of claim 16, wherein the at least one image comprises a table comprising a plurality of numbers disposed in the table.

19. The system of claim 15, wherein the processing portion is further programmed to identify a pattern from the plurality of received selected coordinates; and
determine if the pattern is an agreed upon pattern.

20. (canceled).
